(19) United States
(12) Patent Application Publication
(10) Pub. No.: US 2013/0290021 A1
(43) Pub. Date: Oct. 31, 2013

(54) Method of Establishing Pain Management Protocols

(71) Applicant: Daniel Snell, Pocatello, ID (US)

(72) Inventor: Daniel Snell, Pocatello, ID (US)

(21) Appl. No.: 13/457,780

(22) Filed: Apr. 27, 2012

(51) Int. Cl. G06Q 50/24

(52) U.S. Cl. 705/3

(57) ABSTRACT

The invention discloses a method for implementing pain protocols and reducing patient recovery times. The invention has a dynamically updated database of pain protocols that a consultant can use to improve medical facility conditions. The database contains training information, pain protocol techniques, and information on the effectiveness and use of the pain protocols that the consultant can refer to when evaluating the medical facility's current practices. The consultant establishes a medical director of pain management who then works with the consultant to create a pain protocol plan. The consultant helps the facility implement the plan and monitors the success of the pain management procedures. The database is updated based on the results of this monitoring. The updated database is then shared over the network with other medical facilities.

### BACKGROUND

On Jan. 1, 2001, pain management standards went into effect for Joint Commission accredited ambulatory care facilities, behavioral health care organizations, critical access hospitals, home care providers, hospitals, office-based surgery practices, and long term care providers. The pain management standards address the assessment and management of pain. The standards require organizations to:

recognize the right of patients to appropriate assessment and management of pain;

screen patients for pain during their initial assessment and, when clinically required, during ongoing, periodic re-assessments; and

educate patients suffering from pain and their families about pain management.

This standard creates a huge burden for small facilities that don't have the resources or the training necessary to comply with such requirements. The primary obstacles a facility faces when implementing a pain management system are the lack of training and education for the facility's staff and a way to safely monitor the use of new medication.

In addition, hospitals are generally paid on a per procedure basis, regardless of the patient's actual recovery time. Reducing recover times increases both revenue and the volume of treated patients.

### BRIEF SUMMARY OF INVENTION

The invention discloses a method for implementing pain protocols and reducing patient recovery times. The invention has a dynamically updated database of pain protocols that a consultant can use to improve medical facility conditions. The database contains training information, pain protocol techniques, and information on the effectiveness and use of the pain protocols that the consultant can refer to when evaluating the medical facility's current practices. The consultant establishes a medical director of pain management who then works with the consultant to create a pain protocol plan. The consultant helps the facility implement the plan and monitors the success of the pain management procedures. The database is updated based on the results of this monitoring. The updated database is then shared over the network with other medical facilities.

### BRIEF DESCRIPTION OF THE DRAWINGS

FIG. 1 shows a flowchart and diagram of how the pain protocols are implemented in a medical facility and shared with other medical facilities.

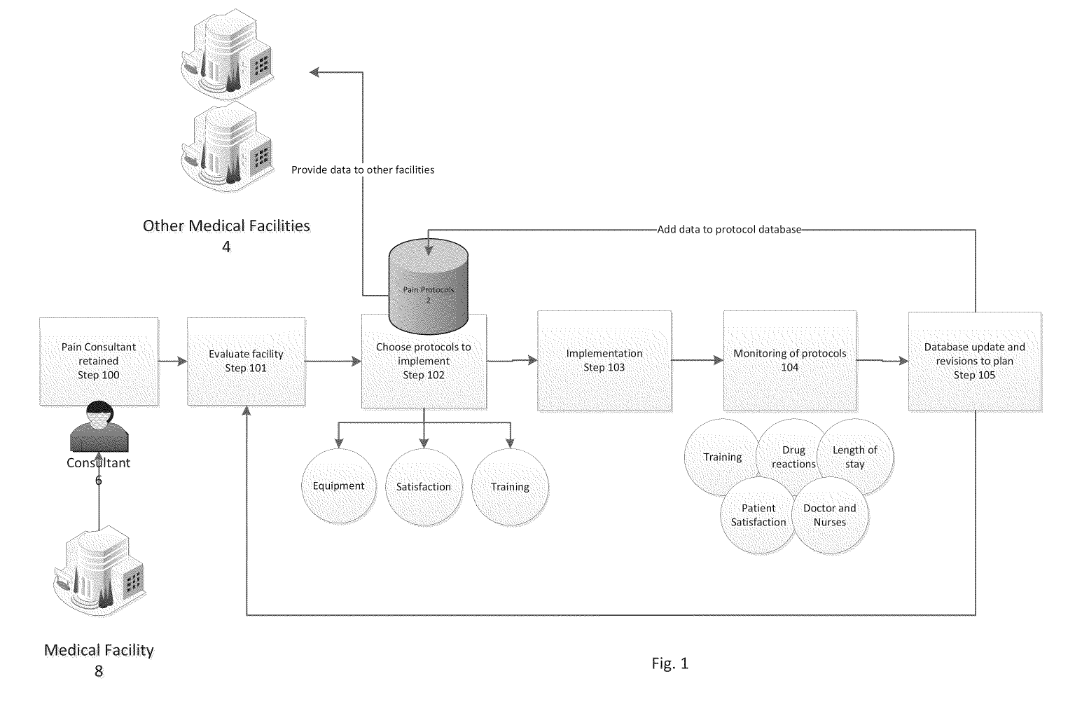

### DETAILED DESCRIPTION OF INVENTION

This invention is a new method of providing pain protocols and pain management training to medical facilities. The invention focuses on providing training and pain protocol to patients in areas where the facility lacks expertise or cannot afford a specialized pain management resource.

In Step 100, the medical facility 8 retains the services of a pain management consultant 6. The pain management consultant is an individual, organization, or group of individuals that provides services related to managing pain in medical facilities, such as doctor offices, hospitals, and recovery clinics. Pain management consultants typically focus on reducing a patient's length of stay at the medical facility, preventing adverse drug reactions, and creating and implementing pain management processes. Pain management consultants are typically responsible for establishing and training a pain management director who then works with the consultant to train nurses and doctors on pain management techniques. This training helps reduce recovery times and ensure that the medical facility is using up-to-date techniques in providing pain treatment to patients. A pain management consultant can be an organization, an individual, or a combination of individuals and organizations.

In Step 101, the pain management consultant 6 evaluates the medical facility 8. This evaluation may include the medical facility's current procedures for managing pain, the skill levels of the medical facility's staff, the equipment available to the medical facility, the current pain protocols used at the medical facility, and the medical facility's budget. The pain management consultant may also establish a medical director for pain management in the medical facility. This medical director is responsible for approving new protocols and managing the training. Appointing a medical director will also allow the medical facility to continue managing its pain protocols and interacting with the protocol database after the consultant has moved on to other facilities.

During Step 101, the pain management consultant typically works closely with an administrator of the medical facility to ensure an accurate understanding. The pain management consultant may also provide the administration a report on his or her findings.

During Step 102, the pain management consultant 6, in connection with the medical facility's administrators, identifies the areas of pain management where improvement is necessary in patient recovery, patient retreatment, and staff training. The pain management consultant uses a database of pain protocols 2 to estimate the areas where improvement is possible. The protocol data may include the average excepted recovery time of patients in other facilities, the pain protocols implemented by other medical facilities, the equipment and training required to implement an improvement, and the level of satisfaction others have experienced with similar protocols. The database may also include order sets and educational presentations that will assist in creating an evidence-based program of pain-management. Pain protocols include instructions on the use of anesthetics, training requirements, post and pre-surgery procedures, and other similar policies and procedures related to patient treatment and recovery.

Pain protocols are the procedures, drugs, equipment, and knowledge the medical facility uses to treat various levels of pain. Pain protocols vary greatly depending on the needs of the facility, the equipment available, and the skill set of the medical staff. For example, the pain protocol may prescribe a certain drug and treatment procedure for patients recovering from a rib fracture while a prescribing a different drug and treatment for those with a hip fracture. Pain protocols may also vary based on the age and weight of the patient. Pain protocols may also include an equivalency chart to allow hospitals to substitute treatment plans to accommodate changing costs and supplies.

The pain protocols are selected based on the medical facilities current and potential structure, such as the medications the medical facility currently uses, the admission procedures and types of patients, the monitoring equipment available, and any current practices already implemented by the facility. The protocols are usually selected by engaging the various departments within the medical facility, including emergency, recovery, surgery, and the anesthesiologist.

In Step 103, the protocols and any necessary training are implemented at the medical facility. The medical facility may choose to implement only a single protocol or multiple protocols. The implementation may include new processes for managing pain, improved training for nurses and doctors, or the purchase of new equipment which, in turn, will allow new pain management techniques to be implemented. Typically, the pain management consultant 6 will oversee or co-oversee the implementation of these protocols to ensure that adequate training is received and that the implementation is carried out in the proper manner.

Education is implemented based on the needs of the hospital, with the goal being to turn the medical facility into a pain management service center. Quarterly trainings are generally sufficient.

In Step 104, the implemented training and protocols are monitored for effectiveness. This includes evaluating how wide-spread the training is, how well the training was implemented, how well the training was understood, the drug reactions that have occurred, especially when compared with previous drug reaction data, patient length of stay, patient, nurse, and doctor satisfaction, and other indicators on the implementation's success. This information can be a combination of numerical data (such as a percent decrease in hospital stay) and survey information (such as for satisfaction information).

Evaluated data may even go beyond patient satisfaction and length of stay information, including the change in a patient's pain data from admission through treatment. Other important information might include the doctor caring for the patient, the attending nurses, and the effectiveness of any medical procedures conducted. The exact nature of the data and how it is collected is usually dependent on the resources and capabilities of the medical facility.

In Step 105, the consultant 6, in no particular order, inputs the gathered data into the protocol database 2, evaluates the data, and updates the protocols and training used in the medical facility 8 based on the results. The consultant will also modify the training and protocols used in the medical facility based on the updated database information. This may include implementing new protocols if the medical facility was not satisfied with the results or failed to achieve a significant decrease in patient stay.

The data can be entered into the protocol database 2 manually or through an automated process. For example, the consultant may upload only the aggregated results using a numerical rating system for each protocol and training or the system can interact with a website designed to gather this data. The data can be fed into the protocol database individually (such as feeding in each survey for review at a later date) or as an aggregate representation of the success of the protocol and training (such as a numerical scored of the ease of implementation, the effectiveness, and the overall satisfaction).

Once this data is collected and added to the protocol database, the data becomes available (via the Internet or through a cloud-based database) to other medical facilities 4 receiving similar consulting services. These other medical facilities can evaluate the response from the first medical facility 8 and tailor their own pain protocols and training based on the feedback sent from the first medical facility. In this manner, consultants have up-to-date information on new pain protocols and actual information on real-world use scenarios. The sharing of this information allows each consultant to effective operate with a vast expanse of knowledge compared to a single individual.

What is claimed is:

1. A method of providing pain management comprising:
a. A database of pain protocols;
b. Implementing pain protocols from the database;
c. Evaluating the implementation of the pain protocols; and
d. Updating the database based on the evaluation.

2. A method according to claim 1, where the pain protocols are implemented at the suggestion of a consultant after an evaluation for the need for such pain protocols has occurred.

3. A method according to claim 1, further comprising establishing a director of pain management.

4. A method according to claim 1, where the evaluation comprises monitoring patient satisfaction.

5. A method according to claim 1, where the evaluation comprises monitoring nurse training and satisfaction.

6. A method according to claim 1, where the implementation of pain protocols comprises providing training and monitoring drug reactions.

7. A method according to claim 1, further comprising revising the implementation of pain protocols based on data obtained during the evaluation.

8. A method according to claim 1, further comprising sharing the updated database.

9. A method according to claim 8, where the protocol database is shared over the cloud.

10. A method according to claim 8, where the database is updated remotely by entering the evaluation data through a web-based interface.

11. A pain management system comprising:
a. A database of pain protocols on a server; and
b. A feedback mechanism that adds additional pain protocols to the database.

12. A system according to claim 11, further comprising a pain management consultant.

13. A system according to claim 11, where the pain protocols comprise training modules and medication procedures.

14. A system according to claim 11, further comprising means of evaluating the implementation of the pain protocols.

15. A system according to claim 11, further comprising data about the implementation of the pain protocols in a medical facility.
